(19) United States
(12) Patent Application Publication
(10) Pub. No.: US 2010/0078465 A1
(43) Pub. Date: Apr. 1, 2010

(54) Paperboard Extrusion Coating Processes and Polymers for Use Therein

(75) Inventor: Dang Le, Houston, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/243,302

(22) Filed: Oct. 1, 2008

(51) Int. Cl. B65D 5/18; B65D 5/74; B31B 3/00

(52) U.S. Cl. 229/103.3; 53/456; 53/485; 229/125.04

(57) ABSTRACT

Packaging materials and methods of forming the same are described herein. The methods generally include providing a paperboard substrate having an exterior surface and an interior surface opposite the exterior surface, coating the exterior surface of the paperboard substrate with a first polymer to form an exterior layer forming a wall structure, forming the wall structure into a packaging material and adhering a closure assembly to the packaging material, wherein a portion of the closure assembly is directly attached to the exterior layer and wherein the portion of the closure assembly is formed of the first polymer.

### FIELD

Embodiments of the present invention generally relate to extrusion coating paperboard and forming containers therefrom.

### BACKGROUND

Paperboard containers are used for packaging numerous products, such as food products (e.g., juice, milk, chicken stock, oil and other products). The paperboard containers are generally formed by extrusion-coating a paperboard substrate with an exterior layer formed of a polymeric material, such as low-density polyethylene (“LDPE”), so that the container is moisture-resistant and more readily printable. The paperboard containers may further include a closure assembly, which may be welded to the inside or outside of the containers, such as by ultrasonic welding. The closure assembly provides an opening through which the contents of the containers may be poured or otherwise dispensed.

In order to effectively secure the closure assembly to the container, a flange formed of a polymeric material dissimilar to that of the exterior layer, such as high density polyethylene (“HDPE”), is generally ultrasonically welded onto the exterior layer of the container. However, obtaining an effective seal between the dissimilar polymeric materials can require lengthy processing times and may result in failing seals.

Therefore, a need exists for an improved method for securing a closure assembly to a paperboard container.

### SUMMARY

Embodiments of the-present invention include methods for producing a packaging material and packaging materials. The methods generally include providing a paperboard substrate having an exterior surface and an interior surface opposite the exterior surface, coating the exterior surface of the paperboard substrate with a first polymer to form an exterior layer forming a wall structure, forming the wall structure into a packaging material and adhering a closure assembly to the packaging material, wherein a portion of the closure assembly is directly attached to the exterior layer and wherein the portion of the closure assembly is formed of the first polymer.

In one or more embodiments, the packaging material is a container. In one or more embodiments, the method generally includes providing a paperboard substrate having an exterior surface and an interior surface opposite the exterior surface, coating the exterior surface of the paperboard substrate with a first propylene based polymer to form an exterior layer and coating the interior surface of the paperboard substrate with a barrier layer to form a wall structure, forming the wall structure into a container and adhering a closure assembly to the container, wherein a portion of the closure assembly is directly attached to the exterior layer and wherein the portion of the closure assembly is formed of a second propylene based polymer.

### BRIEF DESCRIPTION OF DRAWINGS

FIG. 1 illustrates an embodiment of a container.

FIG. 2 illustrates an embodiment of a wall structure of the container of FIG. 1.

FIG. 3 illustrates an embodiment of a closure assembly.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Various ranges are further recited below. It should be recognized that unless stated otherwise, it is intended that the endpoints are to be interchangeable. Further, any point within that range is contemplated as being disclosed herein.

### Catalyst Systems

Catalyst systems useful for polymerizing olefin monomers include any catalyst system known to one skilled in the art. For example, the catalyst system may include metallocene catalyst systems, single site catalyst systems, Ziegler-Natta catalyst systems or combinations thereof, for example. As is known in the art, the catalysts may be activated for subsequent polymerization and may or may not be associated with a support material. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components, such as a catalyst support, a cocatalyst and/or one or more electron donors, for example.

Metallocene catalysts may be characterized generally as coordination compounds incorporating one or more cyclopentadienyl (Cp) groups (which may be substituted or unsubstituted, each substitution being the same or different) coordinated with a transition metal through π bonding. The substituent groups on Cp may be linear, branched or cyclic hydrocarbyl radicals, for example. The cyclic hydrocarbyl radicals may further form other contiguous ring, structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

### Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. The monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, nobornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any method known to one skilled in the art, such as via a double-jacketed pipe or heat exchanger, for example.

Alternatively, other types of polymerization processes may be used, such as stirred reactors in series, parallel or combinations thereof, for example. Upon removal from the reactor, the polymer may be passed to a polymer recovery system for further processing, such as addition of additives and/or extrusion, for example.

### Polymer Product

The polymers (and blends thereof) formed via the processes described herein may include, but are not limited to, linear low density polyethylene, elastomers, plastomers, high density polyethylenes, low density polyethylenes, medium density polyethylenes, polypropylene and polypropylene copolymers, for example.

Unless otherwise designated herein, all testing methods are the current methods at the time of filing.

In one or more embodiments, the polymers include ethylene based polymers. As used herein, the term “ethylene based” is used interchangeably with the terms “ethylene polymer” or “polyethylene” and refers to a polymer having at least about 50 wt. %, or at least about 70 wt. %, or at least about 75 wt. %, or at least about 80 wt. %, or at least about 85 wt. % or at least about 90 wt. % polyethylene relative to the total weight of polymer, for example.

In one or more embodiments, the polymers include low density polyethylene (“LDPE”). As used herein, the term “low density polyethylene” refers to ethylene based polymers having a density of from less than about 0.92 g/cc, for example.

In one or more embodiments, the polymers include medium density polyethylene (“MDPE”). As used herein, the term “medium density polyethylene” refers to ethylene based polymers having a density of from about 0.92 g/cc to about 0.94 g/cc or from about 0.926 g/cc to about 0.94 g/cc, for example.

In one or more embodiments, the polymers include high density polyethylene (“HDPE”). As used herein, the term “high density polyethylene” refers to ethylene based polymers having a density of from about 0.94 g/cc to about 0.97 g/cc, for example.

In one or more embodiments, the polymers include propylene based polymers. As used herein, the term “propylene based” is used interchangeably with the terms “propylene polymer” or “polypropylene” and refers to a polymer having at least about 50 wt. %, or at least about 70 wt. %, or at least about 75 wt. %, or at least about 80 wt. %, or at least about 85 wt. % or at least about 90 wt. % polypropylene relative to the total weight of polymer, for example.

The propylene based polymers may have a molecular weight distribution (Mₙ/M_{w}) of from about 1.5 to about 20, or from about 2 to about 12, for example.

The propylene based polymers may have a melting point (Tₘ) (as measured by DCS) of at least about 110° C., or from about 115° C. to about 175° C., for example.

The propylene based polymers may have a melt flow rate (MFR) (as measured by ASTM D-1238) of from about 0.01 dg/min to about 1000 dg/min., or from about 0.01 dg/min. to about 100 dg/min. or from about 10 dg/min. to about 50 dg/min., for example.

In one or more embodiments, the polymers include polypropylene homopolymers. Unless otherwise specified, the term “polypropylene homopolymer refers to propylene homopolymers or those polymers composed primarily of propylene and limited amounts of other comonomers, such as ethylene, wherein the comonomer make up less than about 0.5 wt. % or less than about 0.1 wt. % by weight of polymer, for example.

In one or more embodiments, the polymers include propylene based random copolymers. Unless otherwise specified, the term “propylene based random copolymer” refers to those copolymers composed primarily of propylene and an amount of other comonomers, wherein the comonomers form at least about 0.5 wt. %, or at least about 0.8 wt. %, or at least about 2 wt. %, or from about 0.5 wt. % to about 1 wt. %, or from about 0.6 wt. % to about 0.8 wt. % comonomer relative to the total weight of polymer, for example.

The comoniomers may be selected from C₂ to C₁₀ alkenes. For example, the comonomliers may be selected from ethylene, propylene, 1-butene, 1-pentene, 1-hexene, 1-heptene, 1-octene, 1-nonene, 1-decene, 4-methyl-1-pentene and combinations thereof. In one specific embodiment, the comonomer includes ethylene. Further, the term “random copolymer” refers to a copolymer formed of macromolecules in which the probability of finding a given monomeric unit at any given site in the chain is independent of the nature of the adjacent units.

In one or more embodiments, the propylene based polymers include stereospecific polymers. As used herein, the term “stereospecific polymer” refers to a polymer having a defined arrangement of molecules in space, such as isotactic and syndiotactic polypropylene, for example. The term “tacticity” refers to the arrangement of pendant groups in a polymer. For example, a polymer is “atactic” when its pendant groups are arranged in a random fashion on both sides of the chain of the polymer. In contrast, a polymer is “isotactic” when all of its pendant groups are arranged on the same side of the chain and “syndiotactic” when its pendant groups alternate on opposite sides of the chain.

In one or more embodiments, the polymers include isotactic polypropylene. As used herein, the term “isotactic polypropylene” refers to polypropylene having a crystallinity measured by ¹³C NMR spectroscopy using meso pentads (e.g., % mmmm) of greater at least about 60%, or at least about 70%, or at least about 80%, or at least about 85% or at least about 90%, for example.

The isotactic polypropylene may have a melting point (Tₘ) (as measured by DSC) of from about 130° C. to about 175° C., or from about 140° C. to about 170° C or from about 150° C. to about 165° C., for example. The isotactic polypropylene may have a molecular weight (M_{w}) (as measured by gel permeation chromatography) of from about 2,000 to about 1,000,000 or from about 100,000 to about 800,000, for example.

In one or more embodiments, the propylene based polymers are formed from metallocene catalyst systems (e.g., metallocene polypropylene).

### Product Application

The polymers and blends thereof are useful in applications known to one skilled in the art such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheet, thermoformed sheet, geomembranes and pond liners, for example. Molded articles include single and multi-layered constructions in the form of bottles, tanks, large hollow articles, rigid food containers and toys, for example.

In one or more embodiments, the polymers are utilized to form paperboard articles. The paperboard articles may include packaging materials, such as containers (e.g., liquid, such as beverage, or food) or cases (e.g., compact disc or video disc), for example.

The paperboard articles generally include a paperboard substrate coated with one or more layers to form a wall structure. The paperboard substrate may include a high grade paperboard stock, 282 pound milk carton board or any other paper or paper-like substance, for example. In addition, the paperboard substrate may be treated, such as via flame treatment, to promote adhesion of subsequent layers disposed thereon.

The thickness of the paperboard substrate may be defined between a paperboard interior surface and a paperboard exterior surface. The thickness of the paperboard substrate may vary widely depending on the intended use of the paperboard substrate. For example, the paperboard substrate thickness may vary from about 0.5 mils to about 7 mils, or from about 3 mils to about 10 mils or the thickness may be more than about 10 mils.

The subsequent layers generally include one or more exterior layers. The one or more exterior layers may be applied to the exterior surface of the paperboard substrate, for example. For example, the subsequent layer may include an exterior layer adapted provide moist-re resistance to the paperboard substrate. Historically, the exterior layer has been formed of an ethylene based polymer, such as low density polyethylene (“LDPE”). In addition, the exterior layer may include surface treatment, such as corona treatment. The corona treatment can be used to aid in surface processes, such as printing, advertising adhesion or label adhesion thereto.

The paperboard substrate may further include one or more interior layers. The interior layers may include barrier layers, tie layers and combinations thereof, for example. The interior layers, the exterior layers or combinations thereof may be formed of a suitable material, such as poly-vinyl alcohols, including ethylene-vinyl alcohol (“EVOH”), chemically modified resins, such as Plexar® resins, commercially available from Equistar Chemicals, ethylene based polymers, propylene based polymers, starch, carboxyl methyl cellulose, metals, combinations thereof or derivatives thereof for example. The one or more exterior layers and/or the one or more interior layers may be adhered to and/or applied to the paperboard substrate via any suitable method. For example, the one or more interior layers and/or exterior layers may be coated, such as extrusion coated, onto the paperboard substrate and/or the subsequent layers on the paperboard substrate. Another example for adhering the one or more interior layers and one or more exterior layers includes a blown or cast film process to coat the paperboard substrate or subsequent layers.

The one or more interior layers may have a total thickness of from about 0.1 mils to about 10 mils, or from about 0.2 mils to about 7 mils or from about 1 mil to about 5 mils, for example.

The resulting wall structure may be formed into paperboard articles by suitable methods. For example, the wall structure may be scored, cut into blanks, and folded to form a container or other paperboard article. The one or more interior layers, the one or more exterior layer and any subsequent layers of the wall structure may be sealed together and/or to the paperboard substrate, such as by side seam heat-sealing, for example.

The container may include a closure assembly (or fitment) mounted or adhered to the wall structure of the container. The closure assembly may permit dispensing contents of the container without tearing, ripping or otherwise opening a top end of the container. In addition, the closure assembly may be reattached to reseal the contents within the container after an initial use as well as subsequent uses. The closure assembly may be adhered or otherwise attached to the wall structure via an opening formed therethrough. The opening may extend through the exterior layer, the interior layer, the paperboard substrate and any subsequent layers to permit dispensing of the contents of the container.

The closure assembly may include a spout for pouring or otherwise removing contents from the container. The spout may be adhered to the container at the opening and may extend from the wall structure of the container, such as the exterior layer of the container. A closure or cap, such terms being used interchangeably herein, may be removably secured to the spout in any conventional manner, such as frictional engagement, threaded engagement, or the like, for example. For example, the spout may have threads on the external surface for engaging the closure or cap. In such an example, a mating thread may be formed on an inner surface of the closure or cap.

Typically, the closure assembly is formed of a material that is dissimilar to that of the exterior layer of the wall structure of the container. For example, traditional closure assemblies are generally formed from polypropylene, while the exterior layer of the wall structure of the container is generally formed from low density polyethylene.

Processes for mounting the closure assembly to the container typically include ultrasonic welding. However, the dissimilar materials of the closure assembly and the exterior layer have resulted in difficulties producing a seal via ultrasonic welding. For example, obtaining an effective seal between the closure assembly and the exterior layer of the container can require long cycle times (e.g., at least about 7 or 8 seconds). Accordingly, prior processes have included mounting the closure assembly to the container via a flange. Historically the flange has been formed of a material that is still dissimilar to that of the closure assembly, such as high density polyethylene, for example. Therefore, similar difficulties have arisen with obtaining an adequate seal between the flange and the exterior layer.

Attempts to improve the seal of the exterior layer and the closure assembly have included over-molding a layer of a low melt polymer onto the flange to reduce cycle time. However, the adhesion between the low melt polymer and the flange is not always sufficient to improve cycle times and/or the seal integrity. In addition, use of the over-molding layer is time consuming and increases the cost of manufacturing the container.

Embodiments of the invention generally utilize a material for the exterior layer of the wall structure that permits direct attachment of the closure assembly to the exterior layer. As a result, the closure assembly may be attached directly to the container without use of the flange. For example, the exterior layer and the closure assembly may comprise similar materials that permit welding or otherwise attaching the closure assembly directly to the exterior layer. For example, one embodiment of the invention includes an exterior layer formed of a propylene based polymer while the cap assembly is secured to the container via a propylene based material. Unexpectedly, embodiments of the invention significantly improve the seal between the closure assembly and the exterior layer while still providing required properties and strength. The improved seal can result in cycle times of about 7 seconds, for example.

While the embodiments described herein are detailed in reference to containers, it is to be understood that the embodiments described herein can be used in other applications, such as for sealing disc (e.g., compact discs, digital video discs) cases to a surrounding paperboard enclosure, for example.

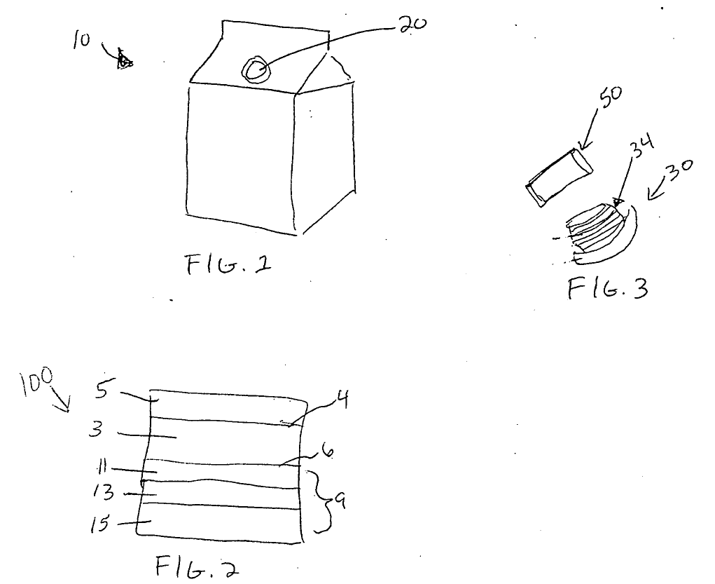

FIG. 1 illustrates an embodiment of a container 10 and FIG. 2 illustrates an embodiment of a wall structure 100 of the container 10. The wall structure 100 includes a paperboard substrate 3 having an interior surface 6 and an exterior surface 4. The thickness of the paperboard substrate 3 may be defined between the interior surface 6 and the exterior surface 4. The wall structure 100 may include one or more layers attached to and/or coated onto the paperboard substrate 3. For example, an exterior layer 5 may be applied to or adhered to the exterior surface 4 of the paperboard substrate 3. In an embodiment, the exterior layer 5 may be extrusion coated onto the exterior surface 4 of the paperboard substrate 3.

The exterior layer 5 may include one or more layers applied to the exterior surface 4 of the paperboard substrate 3. The exterior layer 5 may include one or more tie layers, barrier layers, thermoplastics layers, such as a polymer based layer, and combinations thereof. For example, the exterior layer 5 may include a propylene based layer, such as polypropylene.

The interior surface 6 of the paperboard substrate 3 may be coated or attached to one or more interior layers 9. In an embodiment, the interior surface 6 may have one or more barrier layers 11, one or more tie layers 13 and/or an interior layer 15. The one or more barrier layers 1 and the one or more tie layers 13 may be positioned within the wall structure 100 in any manner. For example, the one or more barrier layers 11 may be positioned adjacent to the paperboard substrate 3 and/or the one or more of the tie layers 13. The one or more tie layers 13 may be positioned adjacent to the paperboard substrate 3 and/or the one or more barrier layers 11.

The interior layer 15, the exterior layer 5 and/or the subsequent layers of the paperboard substrate 3 may be sealed, cut, folded and formed into the container 10. The container 10 may have an opening 20 for dispensing contents of the container 10. The opening 20 may extend through the exterior layer 5 and the interior layer 15 of the container 10. A closure assembly 30 (as shown in FIG. 3) may be attached to the container 10 at the opening 20.

The closure assembly 30 may include a spout 34 and a cap 50. The spout 34 may be attached to the container 10. For example, the spout 34 may be attached directly to the exterior layer 5 at the opening 20 of the container 10. The cap 50 may be secured to the spout 34. For example, the cap 50 may be removably attached to the spout 34 by threaded engagement, frictional engagement, or other manner. In an embodiment, the closure assembly may comprise a hinged cap with a tamper seal that is directly attached to the exterior layer 5 of the container 10.

The exterior layer 5 may be formed a material similar to the closure assembly 30. For example, the closure assembly 30 and the exterior layer 5 may be formed of propylene based polymers, such as a polypropylene. Advantageously, the closure assembly 30 may be attached directly to the exterior layer 5 without use of a flange. The closure assembly 30 may be attached to the container 10 by welding, such as ultrasonic welding, or any other manner. Use of similar materials for the exterior layer 5 and the closure assembly 30 may reduce cycle times for attaching the closure assembly 30 to the container 10. In addition, attaching the closure assembly 30 directly to the exterior layer 5 of the container 10 may eliminate sealing problems and reduce manufacturing and assembly costs.

While the foregoing is directed to embodiments of the present invention, other and further embodiments of the invention may be devised without departing from the basic scope thereof and the scope thereof is determined by the claims that follow.

What is claimed is:

1. A method for producing a packaging material comprising:
providing a paperboard substrate having an exterior surface and an interior surface opposite the exterior surface;
coating the exterior surface of the paperboard substrate with a first polymer to form an exterior layer forming a wall structure;
forming the wall structure into a packaging material; and
adhering a closure assembly to the packaging material, wherein a portion of the closure assembly is directly attached to the exterior layer and wherein the portion of the closure assembly is formed of the first polymer.

2. The method of claim 1, wherein the first polymer is a propylene based polymer.

3. The method of claim 1, wherein the closure assembly is attached to the packaging material without use of a flange.

4. The method of claim 1 further comprising coating the interior surface of the paperboard substrate with a barrier layer.

5. The method of claim 4, wherein the barrier layer comprises a poly-vinyl alcohol.

6. The method of claim 1 further comprising applying a tie layer between the barrier layer and the exterior layer.

7. The method of claim 1, wherein the packaging material is selected from containers and cases.

8. The method of claim 7, wherein the container is a beverage container.

9. The method of claim 1 further comprising ultrasonically welding the closure assembly to the packaging material.

10. The method of claim 1, wherein the closure assembly comprises a spout directly attached to the exterior layer.

11. The method of claim 10, wherein the spout is formed of the first polymer.

12. A packaging material formed from the method of claim 1.

13. A method for producing a container comprising:
providing a paperboard substrate having an exterior surface and an interior surface opposite the exterior surface;
coating the exterior surface of the paperboard substrate with a first propylene based polymer to form an exterior layer and coating the interior surface of the paperboard substrate with a barrier layer to form a wall structure;
forming the wall structure into a container; and
adhering a closure assembly to the container, wherein a portion of the closure assembly is directly attached to the exterior layer and wherein the portion of the closure assembly is formed of a second propylene based polymer.

14. The method of claim 13, wherein the first propylene based polymer and the second propylene based polymer are the same.

15. The method of claim 13, wherein the portion of the closure assembly is a spout attached to the exterior layer at an opening formed in the wall structure of the container, the opening extending through the exterior layer and the paperboard substrate.

16. The method of claim 13, wherein the closure assembly comprises a cap having a hinged connection to the spout.

17. A container formed from the method of claim 13.
